(19) United States
(12) Patent Application Publication
(10) Pub. No.: US 2002/0157013 A1
(43) Pub. Date: Oct. 24, 2002

(54) Copyright licensing process promoting apparatus, copyright licensing process promoting method, copyright licensing process promoting program, and record medium

(76) Inventors: Teruo Masaki, Chiba (JP); Masaya Otsuka, Tokyo (JP); Akihiro Hokimoto, Saitama (JP)

Correspondence Address: COOPER & DUNHAM LLP, 1185 Avenue of the Americas, New York, NY, 10036, US

(21) Appl. No.: 10/090,311

(22) Filed: Mar. 4, 2002

(30) Foreign Application Priority Data
Mar. 5, 2001 (JP) P2001-060059

(51) Int. Cl. H04L 9/32

(52) U.S. Cl. 713/193

(57) ABSTRACT

Literary work data is stored in storing devices of C/Ss. Location information of literary work data is described on a list of a server. Corresponding to the list, a copyright licensing process promoting system supervises the C/Ss. It is determined whether or not a file tried to be transmitted from a C/S is literary work data. When the file tried to be transmitted is literary work data, it is determined whether or not the user has properly performed a predetermined copyright licensing process. When the determined result represents that the copyright licensing process has not been performed, a warning message that requests the user to perform the copyright licensing process is sent to him or her. When the user ignores the warning message and tires to transmit the literary work data, the copyright process promoting system attacks the C/S as the transmission source. For example, the file tried to be transmitted is destroyed.

### BACKGROUND OF THE INVENTION

1. Field of the Invention

The present invention relates to a copyright licensing process promoting apparatus, a copyright licensing process promoting method, and a copyright licensing process promoting program, and a record medium that prevent a literary work from being illegally uploaded to a communication network such as Internet that is open to the public.

2. Description of the Related Art

In recent years, communication networks such as Internet that allows information devices such as computers to connected to each other and to communicate with each other are becoming common at an explosive pace. In particular, the Internet covers most of the world. A very large number of servers are connected to the Internet and a huge number of users are usually accessing the Internet. Under the existing circumstances, it is impossible to accurately know neither all servers connected to the Internet, nor all users accessed thereto.

On the Internet, information is transmitted through serves that function as nodes. To access the Internet, (1) the user should prepare his or her server and connects it to the Internet, (2) the user should contract with a server of a provider for a connection service and connect his or her terminal unit to the Internet through the provider using a dial-up connection, or the user should perform other methods.

On the Internet, the user can upload data to a server and publishes the data to the Internet through the server. As a means for publishing information to the Internet, web pages are used. With the web pages, the user can easily access addresses of the Internet (these addresses are referred to as URL (Uniform Resource Locator)). In addition, for example, with FTP (File Transfer Protocol), the user can directly access data stored in a directory of a server on the Internet.

As was described above, it is very difficult to know the entirety of the Internet. On the Internet, illegal conducts tend to thrive. For example, a person publishes a literary work on the Internet without a permission of the copyright owner. In other words, when a user uploads a literary work that infringes the copyright of another person to a server and it publishes the literary work with a web page, an unspecified number of people can freely obtain the literary work. In such a situation, the copyright of the copyright owner is infringed. Thus, there is a possibility of which the copyright owner loses the benefit that he or she can obtain from the literary work.

On the other hand, there is a system of which many clients store literary works and a server stores a list of the stored literary works and the clients. In the system, a client (called client A) references the list stored in the server and searches the list for a client that has desired literary work data (this client is called client B). The client A directly requests the literary work data of the client B not through the server. In other words, in this system, the server functions as a meta server, whereas a client also functions as a server. In this case, although the server does not store literary work data, since literary work data is exchanged among many clients, there is a possibility of which the copyrights of copyright owners are infringed.

So far, there were limited solutions against such illegal conducts. Infringement conducts are directly attacked in such manners that a server and a client that perform illegal conducts are hacked from the network and that computer programs of the server and client are attacked so that services that are illegal conducts are prevented from being provided and used.

Even if servers and clients that perform illegal conducts are hacked and users who use services that are illegal conducts are attacked, as was described above, since a huge number of clients are accessing the Internet and a very large number of servers are connected thereto, there is no solution that thoroughly solves such a problem.

As another method, a user who performs an illegal conduct may be informed of a warning message. Such a warning message is sent to such a user by electronic mail or the like. However, in such a method, obligatory force against a recipient of such a warning message is weak. Thus, this method cannot prevent such a user from continuing the illegal conduct of which he or she uploads a copyrighted literary work to the server.

### OBJECTS AND SUMMARY OF THE INVENTION

Therefore, an object of the present invention is to provide a copyright licensing process promoting apparatus, a copyright licensing process promoting method, a copyright licensing process promoting program, and a record medium that securely prevent a literary work from being illegally uploaded to a network such as the Internet and allow a copyright licensing process for the literary work to be securely performed.

A first aspect of the present invention is a copyright licensing process promoting apparatus for promoting a copyright licensing process for literary work data transmitted on a communication network, comprising a detecting means for detecting a file of literary work data tried to be transmitted from a terminal unit to the communication network, a content determining means for determining whether or not the content of the file tried to be transmitted to the communication network and detected by the detecting means is valid, and a file processing means for performing a predetermined process for the file before the file is transmitted when the determined result of the content determining means is not valid.

A second aspect of the present invention is a copyright licensing process promoting method for promoting a copyright licensing process for literary work data transmitted on a communication network, comprising the steps of detecting a file of literary work data tried to be transmitted from a terminal unit to the communication network, determining whether or not the content of the file tried to be transmitted to the communication network and detected at the detecting step is valid, and performing a predetermined process for the file before the file is transmitted when the determined result at the content determining step represents that the content of the file is not valid.

A third aspect of the present invention is a copyright licensing process promoting program causing a computer device to perform a copyright licensing process promoting method for promoting a copyright licensing process for literary work data transmitted on a communication network, the method comprising the steps of detecting a file of literary work data tried to be transmitted from a terminal unit to the communication network, determining whether or not the content of the file tried to be transmitted to the communication network and detected at the detecting step is valid, and performing a predetermined process for the file before the file is transmitted when the determined result at the content determining step represents that the content of the file is not valid.

A fourth aspect of the present invention is a record medium on which a copyright licensing process promoting program is recorded, the program causing a computer device to perform a copyright licensing process promoting method for promoting a copyright licensing process for literary work data transmitted on a communication network, the method comprising the steps of detecting a file of literary work data tried to be transmitted from a terminal unit to the communication network, determining whether or not the content of the file tried to be transmitted to the communication network and detected at the detecting step is valid, and performing a predetermined process for the file before the file is transmitted when the determined result at the content determining step represents that the content of the file is not valid.

A fifth aspect of the present invention is a record medium on which a copyright licensing process promoting program is recorded along with literary work data, the program causing a computer device to perform a copyright licensing process promoting method comprising the steps of detecting a file of literary work data tried to be transmitted from a terminal unit to the communication network, determining whether or not the content of the file tried to be transmitted to the communication network and detected at the detecting step is valid, and performing a predetermined process for the file before the file is transmitted when the determined result at the content determining step represents that the content of the file is not valid.

As was described above, according to the present invention, a file of literary work data tried to be transmitted to the network by the user is detected. It is determined whether or not the content of the file tried to be transmitted to the network is valid. When the determined result represents that the content of the file is not valid, before the file is transmitted, a predetermined process is required for the file. Thus, the invalid file can be prevented from being transmitted to the network.

These and other objects, features and advantages of the present invention will become more apparent in light of the following detailed description of a best mode embodiment thereof, as illustrated in the accompanying drawings.

### BRIEF DESCRIPTION OF THE DRAWINGS

FIG. 1 is a schematic diagram showing an example of a system according to a first embodiment of the present invention;

FIG. 2 is a block diagram showing the structure of an example of a copyright licensing process promoting system that checks a file;

FIG. 3 is a schematic diagram showing the structure of an example of music data;

FIG. 4 is a flow chart showing an example of a literary work data transmission preventing process according to the first embodiment of the present invention;

FIG. 5 is a schematic diagram showing an architecture of software of a C/S according to a second embodiment of the present invention;

FIG. 6 is a flow chart showing an example of a literary work data transmission preventing process according to the second embodiment of the present invention; and

FIG. 7 is a flow chart showing a literary work data transmission preventing process according to a third embodiment of the present invention.

### DETAILED DESCRIPTION OF THE PREFERRED EMBODIMENTS

Next, a first embodiment of the present invention will be described. According to the present invention, when a user who is connected to a network tries to transmit literary work of another person as a copyright owner to the network, it is determined whether or not the conduct has been permitted by the copyright owner. When the determined result represents that the conduct has not been permitted by the copyright owner, the user is informed of a warning message that requires him or her to perform a predetermined copyright licensing process. When the user does not obey the warning message, for example the literary work data that the user tries to transmit is attacked and the data that is transmitted is destroyed.

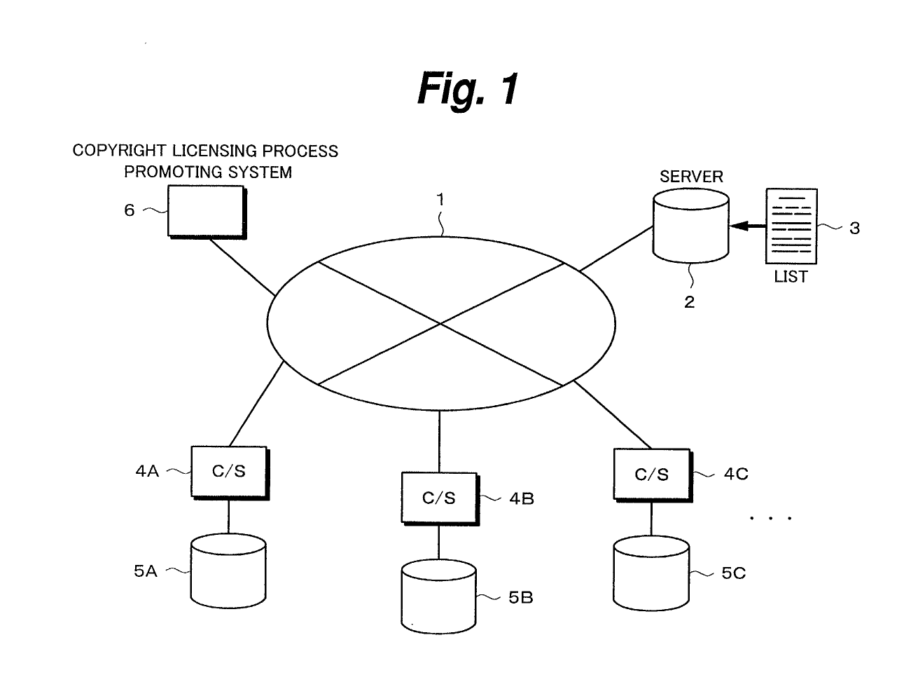

FIG. 1 shows an outline of an example of a system according to the first embodiment of the present invention. A server 2 and clients 4, 4, and so on are connected to a network 1 that is for example Internet. Each of the clients 4, 4, and so on is a client/server machine that has a function as a server to other clients. Hereinafter, the client 4 is denoted by C/S 4. In FIG. 1, to distinguish the C/Ss 4, 4, and so on, they have suffixes A, B, and C. The C/Ss 4, 4, and so on have storing devices 5, 5, and so on that are composed of hard disk drives, respectively. The storing devices 5, 5, and so on store literary work data.

The server 2 stores a list 3 for literary work data stored in the storing devices 5, 5, and so on of the C/Ss 4A, 4B, and so on and for locations in which the literary work data are stored. In other words, the server 2 is a meta server. When literary work data is managed in a hierarchical structure by the storing device 5, location information of the hierarchy is also described on the list 3 along with location information of the C/Ss 4, 4, and so on connected on the network 1. The server 2, the C/Ss 4, 4, and so on, and the storing devices 5, 5, and so on compose a file exchanging system for literary work data.

In the file exchanging system, the user accesses the server 2 with the C/S 4A through the network 1, references the list 3, and searches it for a location in which literary work data that the user desires is stored. Now, it is assumed that the desired literary work data has been stored in a particular directory of the storing device 5C of the C/S 4C. The user searches the list 3 for the desired literary work data. Corresponding to the searched result, the C/S 4A directly accesses the storing device 5C of the C/S 4C through the network 1. As a result, literary work data stored in the storing device 5C is obtained and transmitted from the C/S 4C to the C/S 4A.

On the other hand, a copyright licensing process promoting system 6 is connected to the network 1. The copyright licensing process promoting system 6 accesses the server 2 and obtains the list 3. Corresponding to the obtained list 3, the copyright licensing process promoting system 6 supervises the C/Ss 4, 4, and so on connected to the network 1 and determines whether or not literary work data on the list 3 is tried to be transmitted from the C/Ss 4, 4, and so on to the network 1.

When the copyright licensing process promoting system 6 has detected literary work data tried to be transmitted to the network 1, the copyright licensing process promoting system 6 sends to a C/S 4 as a transmitting source (in this example, C/S 4C) a warning message using electronic mail that requests the C/S 4C to perform a predetermined copyright licensing process. After receiving such a warning message, when the C/S 4C tries to transmit literary work data, the copyright licensing process promoting system 6 attacks the C/S 4C. For example, the copyright licensing process promoting system 6 transmits to the C/S 4C predetermined program data that attacks literary work data that the C/S 4C tries to transmit. Alternatively, the copyright licensing process promoting system 6 may transmit to the C/S 4C program data that causes the system of the C/S 4C not to function.

Using a defect (called bug) of an OS (Operating System) used in the C/Ss 4, 4, and so on or a defect of a browser application that allows the user to browse information published on the network 1, a defect of a file transfer program, or the like, such a program file enters a system area of the C/Ss 4, 4, and so on through the network 1. The execution of the program entered in the system can be triggered when the file is transmitted. The program file is attached with electronic mail. The electronic mail is transferred to a C/S 4 that is a transmission source of literary work data. When the file of the literary work data is transmitted, the program can be executed.

There is a possibility of which the user of a C/S 4 as a transmission source of literary work data has properly performed a predetermined copyright licensing process (namely, the user of the C/S 4 as the copyright source has been changed for the literary work data against the copyright owner). Thus, before the C/S 4 as the transmission source is attacked, it is necessary to determine whether or not the user has performed the copyright licensing process and whether or not the content of the literary work data tried to be transmitted is valid. These determinations are performed by for example the copyright licensing process promoting system 6.

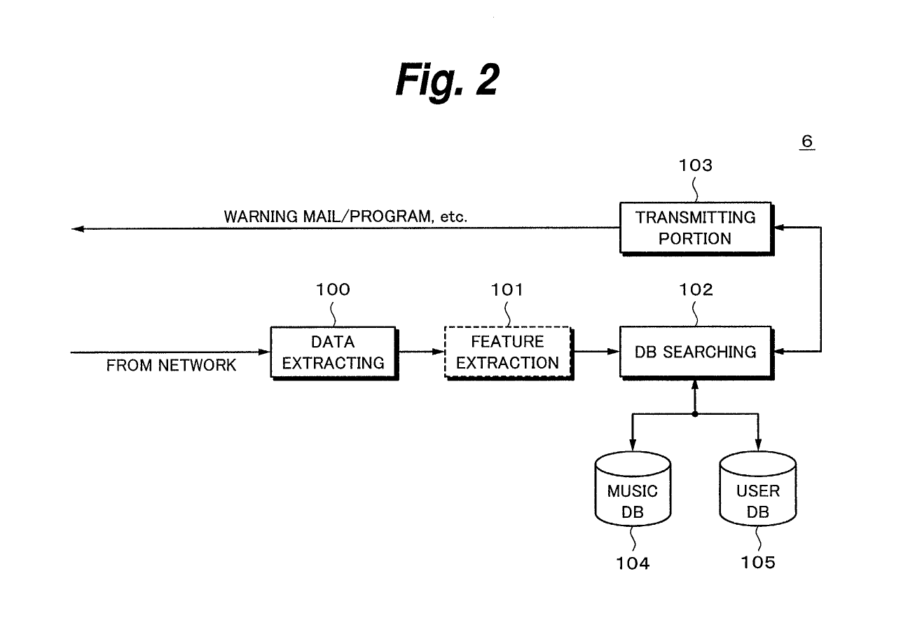

FIG. 2 shows the structure of an example of the copyright licensing process promoting system 6 that performs such determinations. In the following description, it is assumed that literary work data has been recorded on CD (Compact Disc) and copyrighted in a predetermined manner.

A music database 104 stores music information that has been copyrighted and whose copyrights can be managed. A user database 105 stores information of users who has properly performed a predetermined copyright licensing process for music data whose music information is stored in the music database 104.

First of all, information of the C/Ss 4, 4, and so on connected to the network 1 is collected and supplied to a data extracting portion 100. The information can be collected using an automatic collecting program referred to as robot that automatically and successively accesses the C/Ss 4, 4, and so on connected on the network 1. For example, corresponding to a list 3 that is obtained by accessing the server 2, the C/Ss 4, 4, and so on are successively accessed and the contents of the storing devices 5, 5, and so on are checked by the robot.

The data extracting portion 100 extracts required information from the supplied data. A database searching portion 102 searches the music database 104 and the user database 105 corresponding to the extracted information and determines whether a file that is tried to be transmitted from each of the C/Ss 4, 4, and so on is data for which the user has properly performed the copyright licensing process.

Corresponding to the searched result, a transmitting portion 103 sends warning mail to a C/S 4 that tries to transmit literary work data for which the copyright licensing process has not been properly performed. After sending the warning message to the C/S 4, when it tries to transmit literary work data for which the copyright licensing process has not been performed, for example the transmitting portion 103 attacks the C/S 4. It is preferable to transmit warning mail to not only the transmission source of literary work data, but the recipient of the data.

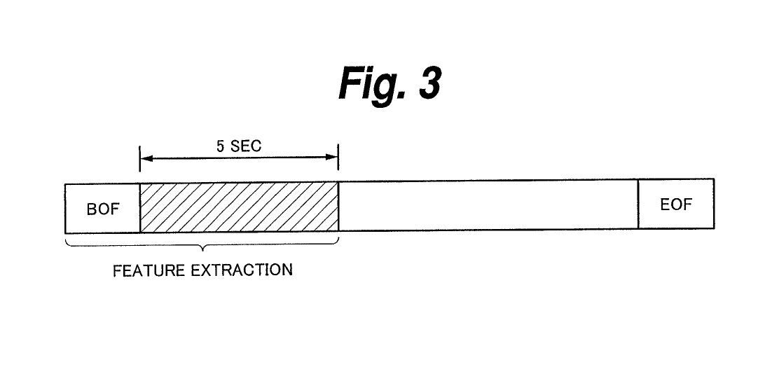

In addition, as denoted by dotted line in FIG. 2, a feature extracting portion 101 that extracts a feature of music data may be disposed in the copyright process promoting system 6. For example, music data tried to be transmitted from each of the C/Ss 4, 4, and so on is supplied to the copyright process promoting system 6 through the network 1. The feature extracting portion 101 extracts a feature portion from the supplied music data and outputs the extracted feature portion as a feature pattern. For example, as a method that has been proposed, a data beginning portion for several seconds is extracted. Corresponding to a frequency characteristic of the music data for several seconds, a feature of data is extracted. Assuming that music data is as shown in FIG. 3, a frequency characteristic for five seconds after BOF (Begin Of File) is obtained by for example FFT (Fast Fourier Transfer). Corresponding to the frequency characteristic, the feature of the data is extracted.

The feature extraction for music data performed by the feature extracting portion 101 is also applicable for music data that has been compression-encoded by a predetermined method such as MP3 (MPEG1 Audio Layer 3). For example, music data that has been compression-encoded is decompressed. The decompressed music data is extracted for three seconds from the beginning. As a result, a feature is extracted. Alternatively, a feature may be extracted corresponding to a compression encoding parameter.

When the feature extracting portion 101 is disposed in the copyright process promoting system 6, the music database 104 correlatively stores feature patterns of music data extracted from the feature extracting portion 101 and attribute information such as song title information of the music data.

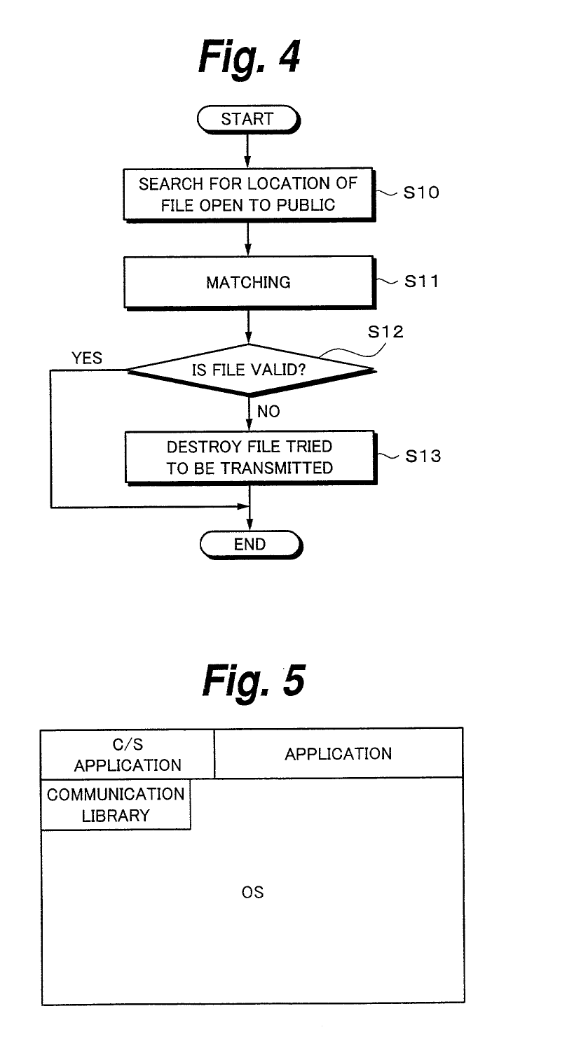

FIG. 4 shows an example of a literary work data transmission preventing process according to the first embodiment of the present invention. The copyright process promoting system 6 supervises the C/Ss 4, 4, and so on connected on the network 1. At step S10 as the first step, the copyright process promoting system 6 searches for a file open to be transmitted and the location thereof.

Corresponding to the list 3 obtained by accessing the server 2, each of the C/Ss 4, 4, and so on are accessed. At that point, the above-mentioned robot can be used. The C/Ss 4, 4, and so on are successively accessed by the robot transmitted from the copyright process promoting system 6 to the network 1 and the contents of the storing devices 5, 5, and so on are checked.

Thereafter, the robot searches the storing devices 5, 5, and so on for files open to be transmitted. For example, corresponding to the states of communication ports of the C/Ss 4, 4, and so on, it can be determined whether or not there are files open to be transmitted. As the searched result, when there is a file open to be transmitted, location information that represents the location of the file is obtained. The location information is composed of information that represents the location on the network 1 and information that represents the location in the storing device 5.

In addition, as the searched result of the robot, a file open to the transmitted is obtained. When literary work data is music data, only data for five seconds is obtained from the beginning. The data obtained by the robot is transmitted to the copyright process promoting system 6 through the network 1 and supplied to the data extracting portion 100. With the data supplied to the data extracting portion 100, the location information of the file open to be transmitted and music data of the obtained file are extracted.

Thereafter, at step S11, a matching process is performed with data extracted by the data extracting portion 100 so as to search for music data that has been copyrighted and that matches data of a file open to be transmitted. For example, music data extracted by the data extracting portion 100 is supplied to the feature extracting portion 101. In the above-described manner, the feature extracting portion 101 extracts a feature from the music data and outputs the extracted feature as a feature pattern. Thereafter, at step S12, the database searching portion 102 searches for music information corresponding to the feature pattern and determines whether or not the music data has been copyrighted.

Thereafter, at step S12, corresponding to the result of the matching process at step S11, it is determined whether or not the file is valid. For example, the user database 105 is further searched for determining whether or not the user who tries to transmit the file has properly performed the predetermined copyright licensing process. When the determined result represents that the user as the transmission source of the file has properly performed the copyright licensing process, assuming that the file is valid, the file is transmitted as it is.

On the other hand, when the determined result at step S12 represents that the user has not performed the copyright licensing process, the flow advances to step S13. At step S13, program data for attacking the file or the system in the above-described manner is transmitted from the transmitting portion 103 to the C/S 4 that tries to transmit the file.

Next, a second embodiment of the present invention will be described. As with the first embodiment, according to the second embodiment, each of the C/Ss 4, 4, and so on is provided with program data for attacking data is used. With the program data, a file that is stored in the storing device 5 of the C/S 4 is tried to be transmitted is detected. When the file is a file for which the copyright licensing process has not been performed, the program data causes the file to be attacked and destroyed.

The system according to the first embodiment shown in FIG. 1 applies to the second embodiment. In addition, the structure shown in FIG. 2 applies to the copyright process promoting system 6.

FIG. 5 shows an outline of an architecture of software of C/Ss 4, 4, and so on according to the second embodiment. An OS (Operating System) 200 controls hardware resource and provides application software 201 (abbreviated as application) with a set of API (Application Programming Interface). A C/S application 202 is an application that provides an interface for a series of processes for referencing the list 3 and obtaining literary work data. Thus, the C/S application 202 operates on the same layer as another application 201.

A function for connecting each of the C/Ss 4, 4, and so on to the network 1 and communicating thereamong is provided to the application 201 and the C/S application 202 by a communication library 203. The communication library 203 is built in the OS 200. The communication library 203 provides the OS 200 with a communication controlling function. According to the second embodiment, the communication library 203 is provided with a file attacking function.

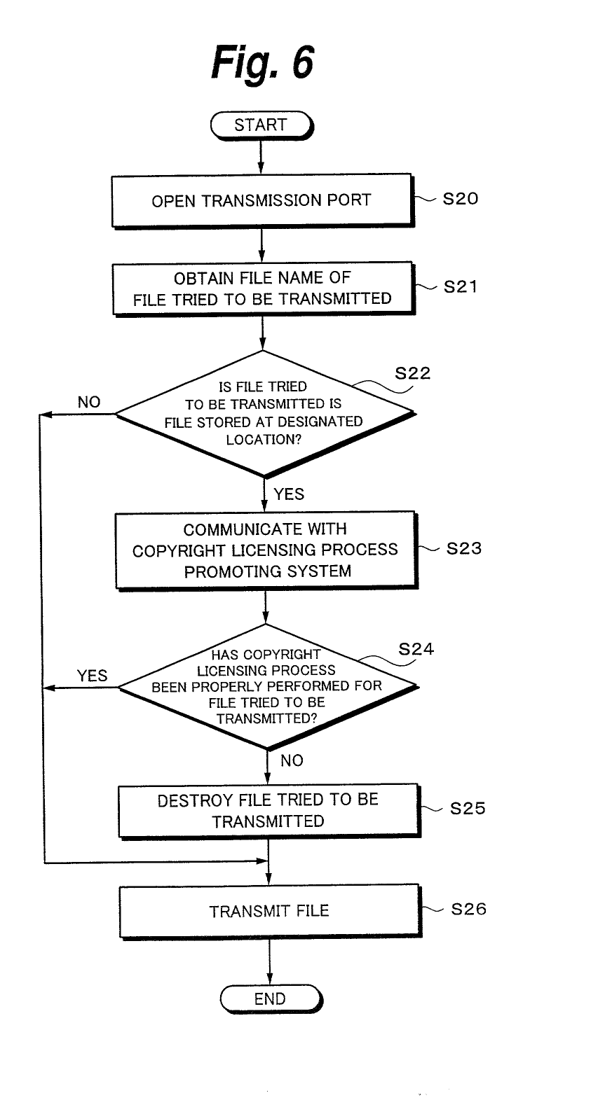

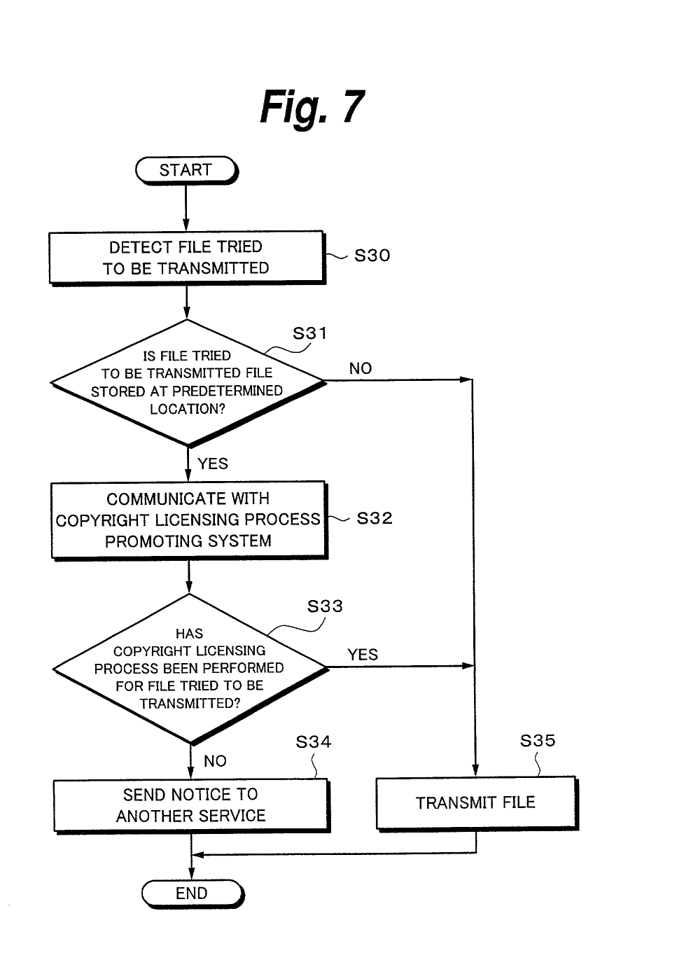

FIG. 6 shows an example of a literary work data transmission preventing process according to the second embodiment. This process is performed corresponding to the function of the communication library 203. In this example, it is assumed that a literary work file is transmitted from the C/S 4A to another C/S 4. When the user causes the C/S 4A to transmit a file, the flow advances to step S20. At step S20, the transmission port is opened and the transmission of the file is prepared. At step S21, the file name of the file to be transmitted is obtained.

Thereafter, at step S22, it is determined whether or not the file to be transmitted is a file stored at a predetermined location of the C/S 4A. For example, the C/S application 202 allocates a location for storing files described on the list 3 and writes allocation information to a preference file. When the C/S 4A is requested to transfer a file by another C/S 4 (for example, C/S 4B), the C/S application of the C/S 4A references the preference file and searches it for the relevant file corresponding to the location allocated in the preference file. At step S22, it is determined whether or not the file tried to be transmitted is a file stored at a location described in the preference file.

When the determined result represents that the file tried to be transmitted is a file stored at a location described in the preference file, the flow advances to step S23. At step S23, the communication library 203 communicates with the copyright process promoting system 6. At step S24, the copyright process promoting system 6 is required to determine whether or not the file tried to be transmitted is a file of music data for which the user has properly performed the copyright licensing process.

Corresponding to the request, the copyright process promoting system 6 accesses the list 3 and determines whether or not the file tried to be transmitted is described on the list 3. In addition, the database searching portion 102 searches the music database 104 and the user database 105 for whether the user has properly performed the copyright licensing process for the file (music data) tried to be transmitted. When the result sent from the copyright process promoting system 6 to the C/S 4A represents that the file tried to be transmitted is described on the list 3 and the user has not properly performed the copyright licensing process, the flow advances to step S25.

At step S25, the file tried to be transmitted is attacked. There are various methods for attacking the file. For example, the content of the file is changed to noise data. The content of the file is deleted except for the header. The file itself is deleted. Alternatively, the content of the file may be substituted with another content. At step S26, the attacked file is transmitted to the C/S 4 designated as a transmission destination.

On the other hand, when the determined result at step S22 represents that the file tried to be transmitted is not a file stored at a predetermined location of the C/S 4A or when the determined result at step S24 represents that the music data tried to be transmitted is a file for which the user has properly performed the copyright licensing process, the flow advances to step S26. At step S26, the file (music data) is transmitted as it is.

When the determined result at step S24 represents that the file tried to be transmitted is a file for which the user has not properly performed the copyright licensing process, the flow advances to step S25. At step S25, the file tried to be transmitted is attacked. However, this operation is only an example. For example, a warning message that requests the user of the C/S 4A to properly perform the predetermined copyright licensing process may be sent to him or her. When the user of the C/S 4 ignores the warning message and tries to transmit the file, the file can be attacked at step S25.

It is preferable to send the warning to not only the transmission source of the file, but the recipient thereof.

The attack performed at step S25 is not limited to the file tried to be transmitted. In other words, the system of the C/S 4A that tries to transmit the file and the C/S application 202 may be attacked. In this case, as was described above, it is preferable to send to the user a warning message that requests him or her to properly perform the predetermined copyright licensing process.

Next, a first modification of the second embodiment will be described. According to the first modification of the second embodiment, a checking program is installed to the C/Ss 4, 4, and so on so as to determine whether or not files stored in the storing devices 5, 5, and so on, exchanged among the C/Ss 4, 4, and so on, and described on the list 3 are destroyed/invalid.

In other words, music data stored in the storing devices 5, 5, and so on may contain music data downloaded from another C/S 4. Such data may be destroyed due to some reasons such as an interruption of a file transfer during downloading. When destroyed music data is reproduced by a system that has downloaded it, there is a possibility of which an error takes place in the system.

To prevent such a situation, a checking program that checks and deletes destroyed music data is installed to the C/Ss 4, 4, and so on. The checking program is executed by user's operation. The checking program checks files of music data stored in the storing device 5 and deletes destroyed files and invalid files from the storing device 5.

In addition, the execution of the checking program can be triggered when a file is transmitted. When the checking program is executed, as with the communication library 202 according to the second embodiment, the file name of the file that is tried to be transmitted is obtained. Thereafter, it is determined whether or not the file is stored at a location designated by the C/S application 201. When the determined result represents that the file is stored at the location designated by the C/S application 201, the file name of the file that is tried to be transmitted is sent to the copyright process promoting system 6 so as to request it to determine whether or not the file tried to be transmitted is a file described on the list 3 and whether or not the music data is a file for which the copyright licensing process has been properly performed.

As a result, when the determined results represent that the file tried to be transmitted is a file described on the list 3 and that the music data is a file for which the copyright licensing process has not been properly performed, a warning message is sent to the user. When the user ignores the warning message and tries to transmit the file, the file is attacked.

It is preferable to send the warning message to not only the file transmission source, but the file recipient.

Next, a second modification of the second embodiment will be described. According to the second modification, the C/S application 201 is provided with the above-described file attacking function. In this case, when a file stored in the storing device 5 is tried to be transmitted to another C/S 4, the C/S application 201 causes the copyright process promoting system 6 to determine whether or not the file tried to be transmitted is a file described on the list 3 and to determine whether or not the copyright licensing process has been properly performed for the music data of the file. When the determined results represent that the file tried to be transmitted is a file described on the list 3 and that the copyright licensing process has not been performed for the music data of the file, the file is attacked.

Next, a third modification of the second embodiment will be described. According to the third modification, the above-described attacking program is attached to for example electronic mail and delivered as a program that enters the system of each of the C/Ss 4, 4, and so on. The execution of the attacking program is triggered when the file is transmitted. When the attacking program is executed, as with the communication library 202 according to the second embodiment, the file name of the file tried to be transmitted is obtained and it is determined whether or not the file is stored at a location designated by the C/S application 201.

When the determined result represents that the file tried to be transmitted is a file stored at a location designated by the C/S application 201, the file name of the file tried to be transmitted is sent to the copyright process promoting system 6 so as to request it to determine whether the file tried to be transmitted is a file described on the list 3 and determine whether or not the copyright licensing process has been properly performed for the music data of the file.

When the determined results represent that the file tried to be transmitted is a file described on the list 3 and that the predetermined copyright licensing process has not been properly performed for the music data of the file, a warning message is sent to the user. When the user ignores the warning message and tries to transmit the file, the file is attacked.

Next, a fourth modification of the second embodiment of the present invention will be described. According to the fourth modification, the above-described attacking program is recorded at a predetermined area of CD (Compact Disc). When the CD on which the attacking program has been recorded is read and the music data is stored to the storing device 5, the attacking program is automatically installed to the C/S 4.

The execution of the program is triggered when the file is transmitted. When the program is executed, as with the communication library 202 according to the second embodiment, the file name of the file tried to be transmitted is obtained. It is determined whether or not the file tried to be transmitted is a file stored at a location designated by the C/S application 201. When the determined result represents that the file tried to be transmitted is a file stored at a location designated by the C/S application 201, it is requested to determine whether or not the file tried to be transmitted is a file described on the list 3 and whether or not the predetermined copyright licensing process has been properly performed for the music data of the file.

When the determined results represent the file tried to be transmitted is a file described on the list 3 and that the predetermined copyright licensing process has not be properly performed for the music data of the file, a warning message is sent to the user. When the user ignores the warning message and tries to transmit the file, the file is attacked.

As an area for the attacking program, VD (Volume Descriptor) defined in CD-ROM (CD-Read Only Memory) can be used. As a type of VD, a VD area for a boot record is formed. In the VD area, an attacking program as a boot file is recorded. Alternatively, a boot file that calls an attacking program recorded in the file area of the CD-ROM and installs the called attacking program to the system is recorded in the VD area.

The CD-ROM is structured as a multi-session disc having music data and the above-described boot file. The multi-session disc from which the music data can be reproduced by a CD player is used as an audio CD. When the music data of the audio CD (CD-ROM) is read by the C/S 4, at first, the boot area is read and then the attacking program is automatically installed to the system of the C/S 4.

According to the fourth modification, a record medium on which literary work data has been recorded is accompanied by an attacking program. In other words, both literary work data and attacking program are distributed at a time. Thus, it can be expected that copyright of literary work data can be securely protected.

According to the fourth modification, it is necessary to define the OS so that the C/S 4 always reads the boot area of the CD-ROM.

Next, a third embodiment of the present invention will be described. According to the third embodiment, when a user who has not been registered to a file exchanging system transmits literary work data for which he or she has not properly performed a predetermined copyright licensing process, other services of a network 1 provided to the user are stopped.

The system according to the first embodiment shown in FIG. 1 applies to the third embodiment. In addition, the structure shown in FIG. 2 applies to the copyright process promoting system 6.

FIG. 7 shows an example of a literary work data transmission preventing process according to the third embodiment. At step S30 as the first step, files of literary work data tried to be transmitted from the C/Ss 4, 4, and so on are detected. The files may be detected by a robot program described in the first embodiment. Alternatively, the copyright process promoting system 6 may supervise the C/Ss 4, 4, and so on. Alternatively, by applying the method for installing an attacking program to the system of each of the C/Ss 4, 4, and so on described in each modification of the second embodiment, a program for detecting the transmission of a file may be installed.

Next, as an example, the case that a file of literary work data is transmitted from the C/S 4A and a predetermined checking program has been installed to the system of the C/S 4A will be described.

Thereafter, at step S31, it is determined whether or not a file tried to be transmitted is a file stored at a predetermined location of the C/S 4A, the location being designated by a file exchanging system. When the determined result represents that the file tried to be transmitted is a file stored at the predetermined position, the flow advances to step S32. At step S32, the checking program causes the C/S 4A and the copyright process promoting system 6 to communicate with each other. Thereafter, at step S33, the copyright process promoting system 6 is requested to determine whether or not the file tried to be transmitted is a file of music data for which the user has properly performed the predetermined copyright licensing process.

Corresponding to the request, the copyright process promoting system 6 accesses the list 3 and determines whether or not the file tried to be transmitted is a file described on the list 3. In addition, the database searching portion 102 searches the music database 104 and the user database 105 for whether the copyright licensing process has been properly performed for the file (music data) tried to be transmitted. When the determined results sent from the copyright process promoting system 6 to the C/S 4A represent that the file tried to be transmitted is a file described on the list 3 and that the predetermined copyright licensing process has not been properly performed for the file, the flow advances to step S34.

At step S34, the copyright process promoting system 6 sends a notice to services of the network 1 that the user of the C/S 4A often uses a notice so as to prohibit the user from using the services. An example of services that the user often uses is a service for searching for information on the network 1.

On the other hand, when the determined result at step S31 represents that the file tried to be transmitted is not a file stored at the predetermined location of the C/S 4A or when the determined result at step S33 represents that the user has properly performed the predetermined copyright licensing process for the music data tried to be transmitted, the flow advances to step S35. At step S35, the file (music data) is transmitted.

Alternatively, at step S34, before a notice is sent to another service, a warning message that requests the user of the C/S 4A to properly perform the predetermined copyright licensing process may be sent to him or her. When the user ignores the warning message and tries to transmit the file of the music data, the notice that requests the server to be stopped is transmitted thereto.

As was described above, according to the present invention, a file tried to be transmitted from a client/server is checked. When the file tried to be transmitted is a file of literary work data registered to a file exchanging network and a predetermined copyright licensing process has not been performed for the file, a warning message is sent to the user. When the user ignores the warning message and tries to transmit the file, a process for causing the user to become disadvantageous is performed. Thus, the user is promoted to perform a copyright licensing process for the literary work data. As a result, legal business of literary work data is promoted.

In addition, according to the first and second embodiments, a file tried to be transmitted is checked. When the file tried to be transmitted is a file of literary work data registered in the file exchanging network and when a predetermined copyright licensing process has not been properly performed for the file, the file is attacked. Thus, the copyright of the literary work data can be protected.

In addition, according to the third embodiment of the present invention, a file tried to be transmitted from a client/server is checked. When the file tried to be transmitted is a file of literary work data registered in the file exchanging network and when a predetermined copyright licensing process has not been performed for the file, a service that the user often uses on the network is caused to be stopped. Thus, the copyright licensing process for the literary work data can be promoted.

Although the present invention has been shown and described with respect to a best mode embodiment thereof, it should be understood by those skilled in the art that the foregoing and various other changes, omissions, and additions in the form and detail thereof may be made therein without departing from the spirit and scope of the present invention.

What is claimed is:

1. A copyright licensing process promoting apparatus for promoting a copyright licensing process for literary work data transmitted on a communication network, comprising:
detecting means for detecting a file of literary work data tried to be transmitted from a terminal unit to the communication network;
content determining means for determining whether or not the content of the file tried to be transmitted to the communication network and detected by said detecting means is valid; and
file processing means for performing a predetermined process for the file before the file is transmitted when the determined result of said content determining means is not valid.

2. The copyright licensing process promoting apparatus as set forth in claim 1, further comprising:
searching means for searching for a location at which a file of literary work data described on a predetermined list is stored, the list being referenced on the communication network,
wherein said detecting means detects the file tried to be transmitted, the file being stored at the location searched by said searching means.

3. The copyright licensing process promoting apparatus as set forth in claim 1,
wherein said content determining means determines that the content of the file is not valid when the content of the file is destroyed.

4. The copyright licensing process promoting apparatus as set forth in claim 1, further comprising:
literary work data determining means for determining whether the content of the file tried to be transmitted is literary work data; and
copyright licensing process determining means for determining whether a copyright licensing process has been performed for literary work data,
wherein said content determining means determines that the content of the file is valid corresponding to the determined result of said literary work data determining means and the determined result of said copyright licensing process determining means that represent that the content of the file is literary work data and the predetermined copyright licensing process has not been performed for the file.

5. The copyright licensing process promoting apparatus as set forth in claim 1,
wherein the predetermined process performed by said file processing means is a process for destroying the file.

6. The copyright licensing process promoting apparatus as set forth in claim 1,
wherein the predetermined process performed by said file processing means is a process for deleting the file.

7. The copyright licensing process promoting apparatus as set forth in claim 1, further comprising:
informing means for informing the user of the terminal unit that the content of the file is not valid when the determined result of said content determining means represents that the content of the file is not valid,
wherein said file processing means performs the predetermined process when the terminal unit tries to transmit the file although said informing means has informed the user that the content of the file is not valid.

8. A copyright licensing process promoting method for promoting a copyright licensing process for literary work data transmitted on a communication network, comprising the steps of:
detecting a file of literary work data tried to be transmitted from a terminal unit to the communication network;
determining whether or not the content of the file tried to be transmitted to the communication network and detected at the detecting step is valid; and
performing a predetermined process for the file before the file is transmitted when the determined result at the content determining step represents that the content of the file is not valid.

9. A copyright licensing process promoting program causing a computer device to perform a copyright licensing process promoting method for promoting a copyright licensing process for literary work data transmitted on a communication network, the method comprising the steps of:
detecting a file of literary work data tried to be transmitted from a terminal unit to the communication network;
determining whether or not the content of the file tried to be transmitted to the communication network and detected at the detecting step is valid; and
performing a predetermined process for the file before the file is transmitted when the determined result at the content determining step represents that the content of the file is not valid.

10. The copyright licensing process promoting program as set forth in claim 9,
wherein the copyright licensing process promoting program is supplied from the network to the terminal unit.

11. The copyright licensing process promoting program as set forth in claim 9,
wherein the copyright licensing process promoting program is built in the terminal unit.

12. The copyright licensing process promoting program as set forth in claim 9,
wherein the copyright licensing process promoting program is recorded on a record medium along with literary work data and supplied to the terminal unit.

13. A record medium on which a copyright licensing process promoting program is recorded, the program causing a computer device to perform a copyright licensing process promoting method for promoting a copyright licensing process for literary work data transmitted on a communication network, the method comprising the steps of:
detecting a file of literary work data tried to be transmitted from a terminal unit to the communication network;
determining whether or not the content of the file tried to be transmitted to the communication network and detected at the detecting step is valid; and
performing a predetermined process for the file before the file is transmitted when the determined result at the content determining step represents that the content of the file is not valid.

14. A record medium on which a copyright licensing process promoting program is recorded along with literary work data, the program causing a computer device to perform a copyright licensing process promoting method comprising the steps of:
detecting a file of literary work data tried to be transmitted from a terminal unit to the communication network;
determining whether or not the content of the file tried to be transmitted to the communication network and detected at the detecting step is valid; and
performing a predetermined process for the file before the file is transmitted when the determined result at the content determining step represents that the content of the file is not valid.
